(19) United States
(12) Patent Application Publication
(10) Pub. No.: US 2025/0019215 A1
(43) Pub. Date: Jan. 16, 2025

(54) CARGO HANDLING SYSTEM

(71) Applicants: KABUSHIKI KAISHA TOYOTA JIDOSHOKKI, Kariya-shi (JP); NATIONAL INSTITUTE OF ADVANCED INDUSTRIAL SCIENCE AND TECHNOLOGY, Tokyo (JP)

(72) Inventors: Yukikazu KOIDE, Tsukuba-shi (JP); Hironobu OKAMOTO, Tsukuba-shi (JP); Shinichi MAE, Tsukuba-shi (JP); Naoya YOKOMACHI, Kariya-shi (JP); Koji FUJII, Kariya-shi (JP); Takashi OKUMA, Tsukuba-shi (JP); Hirokatsu KATAOKA, Tsukuba-shi (JP); Mitsuru KAWAMOTO, Tsukuba-shi (JP); Ryusuke SAGAWA, Tsukuba-shi (JP); Eiichi YOSHIDA, Tsukuba-shi (JP)

(73) Assignees: KABUSHIKI KAISHA TOYOTA JIDOSHOKKI, Kariya-shi (JP); NATIONAL INSTITUTE OF ADVANCED INDUSTRIAL SCIENCE AND TECHNOLOGY, Tokyo (JP)

(21) Appl. No.: 18/767,067

(22) Filed: Jul. 9, 2024

(30) Foreign Application Priority Data
Jul. 13, 2023 (JP) 2023-114973

(51) Int. Cl. B66F 9/06

(52) U.S. Cl. CPC B66F 9/063

(57) ABSTRACT

A cargo handling system includes: a first detection unit configured to detect a cargo on a pallet held by a fork of a forklift as a loaded state together with the pallet using at least one type of sensor before cargo handling work is started; a first abnormality determination unit configured to determine whether the loaded state detected by the first detection unit is abnormal; a second detection unit configured to detect a work situation using a plurality of types of sensors after the cargo handling work is started; and a second abnormality determination unit configured to determine whether the work situation detected by the second detection unit is abnormal.

### CROSS REFERENCE TO RELATED APPLICATIONS

This application claims priority to Japanese Patent Application No. 2023-114973 filed on Jul. 13, 2023, the entire contents of which are incorporated by reference herein.

### TECHNICAL FIELD

The present disclosure relates to a cargo handling system.

### BACKGROUND

For example, Japanese Unexamined Patent Publication No. 2005-8367 describes detecting whether or not a fork is inclined in a front-back direction or a height of a fork is displaced with respect to a direction in which the fork is inserted into a fork insertion hole of a pallet based on a plurality of sensors provided at a distal end portion and a proximal end portion of the fork of a forklift, determining an operation mode for correcting the inclination and the height of the fork, and inserting the fork into the fork insertion hole of the pallet by causing the fork to operate according to the operation mode.

### SUMMARY

Meanwhile, if a cargo on the pallet is laterally displaced, adjacent cargos may interfere with each other, leading to occurrence of so-called cargo shifting in which the cargos on the pallet fall down. In addition, even if a possibility of occurrence of cargo shifting is low before cargo handling work, there is a possibility that a situation leading to cargo shifting may occur during the cargo handling work.

An object of the present disclosure is to provide a cargo handling system capable of suppressing occurrence of cargo shifting.

(1) One aspect of the present disclosure is a cargo handling system that performs cargo handling work with a forklift, the cargo handling system including: a first detection unit configured to detect a cargo on a pallet held by a fork of the forklift as a loaded state together with the pallet using at least one type of sensor before the cargo handling work is started; a first abnormality determination unit configured to determine whether the loaded state detected by the first detection unit is abnormal; a second detection unit configured to detect a work situation using a plurality of types of sensors after the cargo handling work is started; and a second abnormality determination unit configured to determine whether the work situation detected by the second detection unit is abnormal.

In such a cargo handling system, before the cargo handling work is started, the cargo on the pallet held by the fork is detected as the loaded state together with the pallet using at least one type of sensor, and it is determined whether the loaded state is abnormal. When it is determined that the loaded state is abnormal, it is possible to suppress occurrence of cargo shifting due to interference, or the like, between adjacent cargos by stopping the cargo handling work or performing operation of avoiding cargo shifting. After the cargo handling work is started, the work situation is detected using a plurality of types of sensors, and it is determined whether the work situation is abnormal. When it is determined that the work situation is abnormal, it is possible to suppress occurrence of cargo shifting to be caused by a situation leading to cargo shifting, such as dragging of the cargo, by stopping the cargo handling work or performing operation of avoiding cargo shifting.

(2) In the above (1), the one type of sensor may be a camera that captures an image of the pallet and the cargo. In such a configuration, the loaded state including the cargo and the pallet can be easily and inexpensively detected by using the camera.

(3) In the above (1) or (2), the plurality of types of sensors may include a camera that captures an image of the pallet and the cargo, a microphone that collects sound around the forklift, and a vibration sensor that measures vibration applied to the fork. In such a configuration, by using the camera, the microphone, and the vibration sensor, it is possible to detect, in a wide range and with high accuracy, an abnormality in the work situation that leads to cargo shifting, such as dragging of the cargo and collision between cargos which occur during the cargo handling work.

(4) In any one of (1) to (3), the cargo handling system may further include a storage unit configured to store modeled data in which operation data of the forklift by an operator is associated with information on the loaded state detected by the first detection unit and information on the work situation detected by the second detection unit when the cargo handling work is performed by manual operation of the forklift, the first abnormality determination unit may determine whether the loaded state detected by the first detection unit is abnormal using the modeled data stored in the storage unit, and the second abnormality determination unit may determine whether the work situation detected by the second detection unit is abnormal using the modeled data stored in the storage unit. In such a configuration, by using the modeled data in which the operation data of the forklift by the operator is associated with the information on the loaded state detected by the first detection unit and the information on the work situation detected by the second detection unit at the time of the operation of the forklift, whether the loaded state and the work situation are abnormal is determined based on a result of modeling actual abnormality recognition and judgement by the operator. It is therefore possible to appropriately determine whether or not the loaded state and the work situation are abnormal.

(5) In any one of the above (1) to (4), the cargo handling system may further include: an avoidance plan creation unit configured to create avoidance plan data for avoiding cargo shifting of the cargo when the first abnormality determination unit determines that the loaded state is abnormal or when the second abnormality determination unit determines that the work situation is abnormal; and a cargo handling control unit configured to control the forklift to perform the cargo handling work in accordance with the avoidance plan data created by the avoidance plan creation unit. In such a configuration, when it is determined that the loaded state or the work situation is abnormal, avoidance plan data for avoiding cargo shifting is created, and the forklift is controlled to perform the cargo handling work according to the avoidance plan data. Thus, occurrence of cargo shifting is automatically suppressed.

(6) In (5) described above, the cargo handling system may further include an avoidance possibility determination unit configured to determine whether cargo shifting of the cargo is avoidable when the first abnormality determination unit determines that the loaded state is abnormal or when the second abnormality determination unit determines that the work situation is abnormal, the avoidance plan creation unit may create the avoidance plan data when the avoidance possibility determination unit determines that the cargo shifting is avoidable, and the cargo handling control unit may control the forklift to stop the cargo handling work when the avoidance possibility determination unit determines that the cargo shifting is not avoidable. In such a configuration, in a case where it is determined that the loaded state or the work situation is abnormal, the avoidance plan data is created when it is determined that the cargo shifting is avoidable, and the forklift is controlled to stop the cargo handling work when it is determined that the cargo shifting is not avoidable. The avoidance plan data is created as necessary in this manner, so that it is not necessary to wastefully create the avoidance plan data. This can simplify the processing.

(7) In (5) or (6) described above, the cargo handling system may further include a storage unit configured to store modeled data in which operation data of the forklift by the operator is associated with information on the loaded state detected by the first detection unit and information on the work situation detected by the second detection unit when the cargo handling work is performed by manual operation of the forklift, and the avoidance possibility determination unit may determine whether the cargo shifting of the cargo is avoidable using the modeled data stored in the storage unit. In such a configuration, by using the modeled data in which the operation data of the forklift by the operator is associated with the information on the loaded state detected by the first detection unit and the information on the work situation detected by the second detection unit at the time of the operation of the forklift, whether cargo shifting of the cargo is avoidable is determined based on a result of modeling actual abnormality recognition and judgement by the operator. It is therefore possible to appropriately determine whether or not cargo shifting of the cargo is avoidable.

(8) In (5) or (6) described above, the cargo handling system may further include a storage unit configured to store modeled data in which operation data of the forklift by an operator is associated with information on the loaded state detected by the first detection unit and information on the work situation detected by the second detection unit when the cargo handling work is performed by manual operation of the forklift, and the avoidance plan creation unit may create the avoidance plan data using the information on the loaded state detected by the first detection unit and the modeled data stored in the storage unit in a case where the first abnormality determination unit determines that the loaded state is abnormal and when it is determined that the cargo shifting is avoidable, and may create the avoidance plan data using the information on the work situation detected by the second detection unit and the modeled data stored in the storage unit in a case where the second abnormality determination unit determines that the work situation is abnormal and when it is determined that the cargo shifting is avoidable. In such a configuration, by creating the avoidance plan data using the modeled data in which the operation data of the forklift by the operator is associated with the information on the loaded state detected by the first detection unit and the information on the work situation detected by the second detection unit at the time of the operation of the forklift, it is possible to obtain the avoidance plan data based on a result of modeling actual abnormality recognition and judgement by the operator. Thus, occurrence of cargo shifting can be appropriately suppressed.

According to the present disclosure, it is possible to suppress occurrence of cargo shifting.

### BRIEF DESCRIPTION OF THE DRAWINGS

FIG. 1 is a side view illustrating a forklift to which a cargo handling system according to an embodiment of the present disclosure is applied;

FIG. 2 is a block diagram illustrating a configuration of the cargo handling system according to an embodiment of the present disclosure;

FIG. 3 is a front view illustrating a state in which cargos on adjacent pallets interfere with each other;

FIG. 4 is a flowchart indicating procedure of loaded state determination processing to be executed by a controller illustrated in FIG. 2;

FIG. 5 is a flowchart indicating procedure of work situation determination processing to be executed by the controller illustrated in FIG. 2;

FIG. 6 is a flowchart indicating procedure of avoidance plan creation processing to be executed by an avoidance plan creation unit of the controller illustrated in FIG. 2; and

FIG. 7 is a flowchart indicating procedure of cargo handling control processing to be executed by a cargo handling control unit of the controller illustrated in FIG. 2.

### DETAILED DESCRIPTION

An embodiment of the present disclosure will be described in detail below with reference to the drawings.

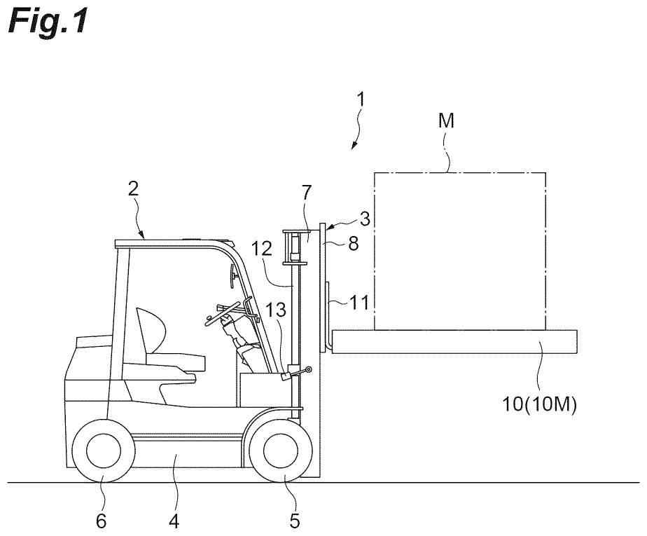

FIG. 1 is a side view illustrating a forklift to which a cargo handling system according to an embodiment of the present disclosure is applied. In FIG. 1, a forklift 1 is, for example, a counter type forklift. The forklift 1 includes a traveling device 2 and a cargo handling device 3.

The traveling device 2 includes a vehicle body 4, front wheels 5 which are a pair of left and right drive wheels disposed at a front portion of the vehicle body 4, and rear wheels 6 which are a pair of left and right steering wheels disposed at a rear portion of the vehicle body 4.

The cargo handling device 3 includes a mast 7 attached to a front end portion of the vehicle body 4, a pair of right and left forks 11 that are attached to the mast 7 so as to be movable up and down via a lift bracket 8 and hold a pallet 10, a lift cylinder 12 that moves up and down the forks 11 via the lift bracket 8, and a tilt cylinder 13 that tilts the mast 7.

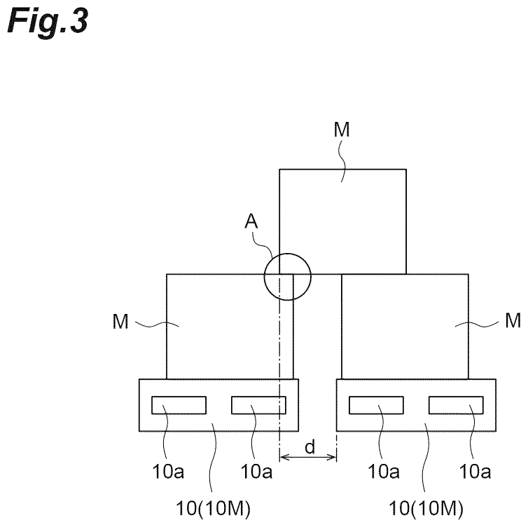

The pallet 10 is, for example, a flat pallet made of plastic or wood. The pallet 10 has a square shape or a substantially square shape in planar view. A cargo M is loaded on the pallet 10. The pallet 10 is provided with a pair of left and right fork holes 10a (see FIG. 3) into which the forks 11 are to be inserted.

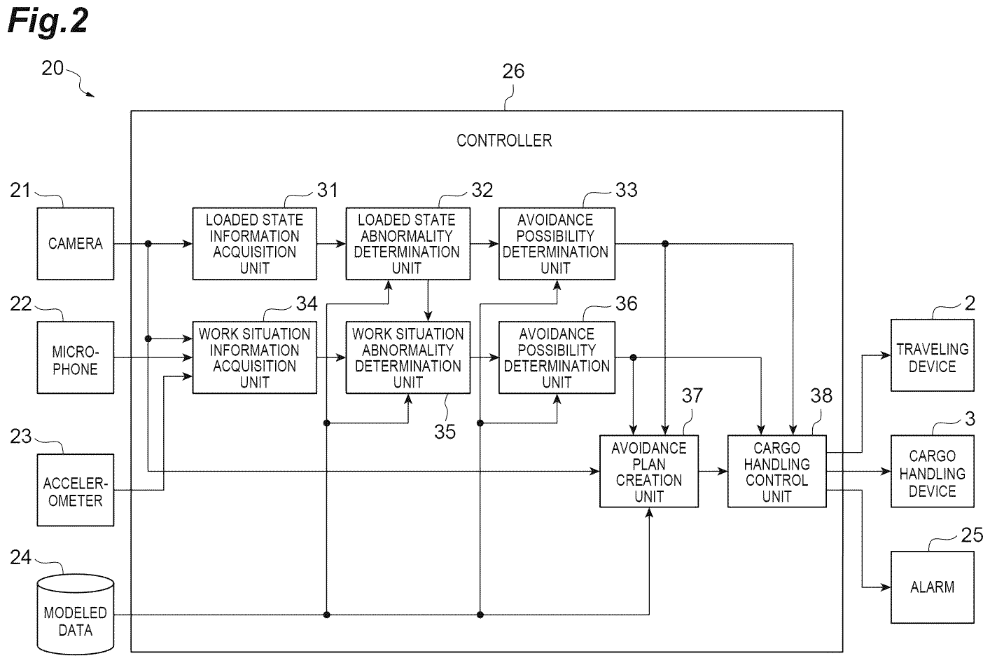

FIG. 2 is a block diagram illustrating a configuration of the cargo handling system according to an embodiment of the present disclosure. In FIG. 2, the cargo handling system 20 of the present embodiment is a system that controls the forklift 1 so as to perform cargo handling work by automatic operation of the forklift 1. Here, the cargo handling system 20 performs picking-up work as cargo handling work. The cargo picking-up work is work of flow including inserting the forks 11 into the fork holes 10a of the pallet 10 on which the cargo M is loaded (hereinafter, it may be referred to as a loaded pallet 10M), raising the forks 11 to lift the loaded pallet 10M, and pulling out the loaded pallet 10M.

The cargo handling system 20 is mounted on the forklift 1. The cargo handling system 20 includes a camera 21, a microphone 22, an accelerometer 23, a storage unit 24, an alarm 25, and a controller 26.

The camera 21 is an image sensor that captures an image of the pallet 10 and the cargo M (loaded pallet 10M) present in front of the forklift 1 and acquires captured image data. The loaded pallet 10M present in front of the forklift 1 also includes the loaded pallet 10M held by the forks 11. The camera 21 is attached to, for example, the mast 7.

The microphone 22 is a sound collection sensor that collects sound around the forklift 1 and acquires sound collection data. The microphone 22 is attached to, for example, the mast 7.

The accelerometer 23 is a vibration sensor that detects vibration applied to the forks 11 of the forklift 1 by measuring acceleration of the forklift 1 and acquires vibration data. The accelerometer 23 is attached to, for example, the forks 11.

The storage unit 24 stores modeled data in which operation data of the forklift 1 by an operator is associated with the image data of the loaded pallet 10M acquired by the camera 21, the sound collection data acquired by the microphone 22, and the vibration data acquired by the accelerometer 23 when cargo handling work is performed by manual operation of the forklift 1. The modeled data is data obtained by collecting in advance data related to recognition, judgment, and operation by a human with respect to various loaded states and work situations, and performing modeling by deep learning, or the like, using the collected data.

The alarm 25 is a device that issues an alarm to the surroundings by alarm sound, or the like, when there is a possibility that cargo shifting of the cargo M on the pallet 10 may occur.

The controller 26 is constituted with a CPU, a RAM, a ROM, an input/output interface, and the like. The controller 26 includes a loaded state information acquisition unit 31, a loaded state abnormality determination unit 32, an avoidance possibility determination unit 33, a work situation information acquisition unit 34, a work situation abnormality determination unit 35, an avoidance possibility determination unit 36, an avoidance plan creation unit 37, and a cargo handling control unit 38.

The loaded state information acquisition unit 31 acquires image data of the camera 21 as loaded state information of the loaded pallet 10M before starting cargo handling work. The loaded state of the loaded pallet 10M includes not only the loaded state of the loaded pallet 10M for which cargo handling is to be performed but also the loaded state of the loaded pallet 10M adjacent to the loaded pallet 10M for which cargo handling is to be performed (see FIG. 3). The loaded state information acquisition unit 31 cooperates with the camera 21 to constitute a first detection unit that detects the cargo M on the pallet 10 held by the forks 11 of the forklift 1 as a loaded state together with the pallet 10 using at least one type of sensor before starting the cargo handling work.

The loaded state abnormality determination unit 32 uses the modeled data stored in the storage unit 24 to determine whether the loaded state of the loaded pallet 10M acquired by the loaded state information acquisition unit 31 is abnormal. A state in which the loaded state of the loaded pallet 10M is abnormal is a state in which there is a possibility that cargo shifting occurs due to interference, or the like, between the cargos M adjacent in a horizontal direction. The loaded state abnormality determination unit 32 constitutes a first abnormality determination unit that determines whether the loaded state detected by the first detection unit is abnormal.

When the loaded state abnormality determination unit 32 determines that the loaded state of the loaded pallet 10M is abnormal, the avoidance possibility determination unit 33 determines whether cargo shifting is avoidable using the modeled data stored in the storage unit 24.

After the cargo handling work is started, the work situation information acquisition unit 34 acquires the image data of the camera 21, the sound collection data of the microphone 22, and the vibration data of the accelerometer 23 as work situation information. The work situation information acquisition unit 34 constitutes a second detection unit that detects the work situation using a plurality of types of sensors after the cargo handling work is started in cooperation with the camera 21, the microphone 22, and the accelerometer 23.

The work situation abnormality determination unit 35 determines whether the work situation acquired by the work situation information acquisition unit 34 is abnormal using the modeled data stored in the storage unit 24. A state in which the work situation is abnormal is a state in which cargo shifting may occur due to a situation that leads to the cargo shifting, such as dragging of the cargo M, collision between the cargos M, and lifting of the adjacent cargo M. The work situation abnormality determination unit 35 constitutes a second abnormality determination unit that determines whether the work situation detected by the second detection unit is abnormal.

When the work situation abnormality determination unit 35 determines that the work situation is abnormal, the avoidance possibility determination unit 36 determines whether cargo shifting is avoidable using the modeled data stored in the storage unit 24.

When the avoidance possibility determination units 33 and 36 determine that cargo shifting is avoidable, the avoidance plan creation unit 37 creates avoidance plan data for avoiding the cargo shifting using the image data of the camera 21, the sound collection data of the microphone 22, the vibration data of the accelerometer 23, and the modeled data stored in the storage unit 24. The avoidance plan data will be described in detail later.

When the avoidance possibility determination units 33 and 36 determine that cargo shifting is avoidable, the cargo handling control unit 38 controls the traveling device 2 and the cargo handling device 3 to perform the cargo handling work according to the avoidance plan data created by the avoidance plan creation unit 37. When the avoidance possibility determination units 33 and 36 determine that cargo shifting is not avoidable, the cargo handling control unit 38 controls the traveling device 2 and the cargo handling device 3 so as to stop the cargo handling work and controls the alarm 25 so as to issue an alarm.

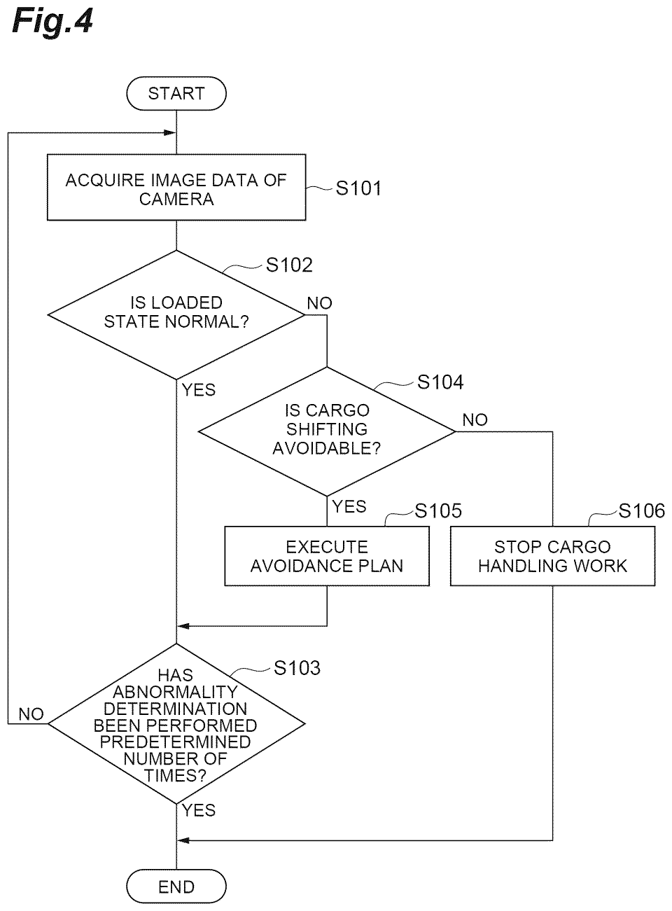

FIG. 4 is a flowchart indicating procedure of loaded state determination processing to be executed by the controller 26. This processing is executed by the loaded state information acquisition unit 31, the loaded state abnormality determination unit 32, and the avoidance possibility determination unit 33. This processing is executed before the cargo handling work is started in a state where the forklift 1 has reached a position in front of the loaded pallet 10M.

In FIG. 4, the controller 26 first acquires image data of the camera 21 (step S101). Subsequently, the controller 26 judges whether a current loaded state of the loaded pallet 10M is normal based on the image data of the camera 21 (step S102). For example, as illustrated in FIG. 3, in a case where the cargo M on the pallet 10 interferes with the cargo M on the adjacent pallet 10 (see A in the drawing), the loaded state of the cargo is abnormal.

In this event, a threshold to be used for abnormality judgement of the loaded state is calculated from the modeled data stored in the storage unit 24. For example, as illustrated in FIG. 3, when a protruding amount d of the cargo M with respect to the pallet 10 is equal to or larger than the threshold, there is a risk of occurrence of cargo shifting, and thus, it is judged that the loaded state is abnormal.

When it is judged that a current loaded state of the loaded pallet 10M is normal, the controller 26 judges whether the loaded state abnormality determination has been performed a predetermined number of times (step S103). The predetermined number of times is one or a plurality of times. When it is judged that the loaded state abnormality determination has been performed a predetermined number of times, the controller 26 ends this processing. When it is judged that the loaded state abnormality determination has not been performed a predetermined number of times, the controller 26 executes the above processing in step S101 again.

When it is judged that the current loaded state of the loaded pallet 10M is abnormal in step S102, the controller 26 judges whether cargo shifting is avoidable using the modeled data stored in the storage unit 24 (step S104).

When it is judged that cargo shifting is avoidable, the controller 26 outputs that the avoidance plan is to be executed (step S105) and executes the processing in step S103. When it is judged that cargo shifting is not avoidable, the controller 26 outputs that the cargo handling work is to be stopped (step S106) and ends this processing.

Here, the loaded state information acquisition unit 31 executes the processing in step S101 and step S103. The loaded state abnormality determination unit 32 executes the processing in step S102. The avoidance possibility determination unit 33 executes the processing from step S104 to step S106.

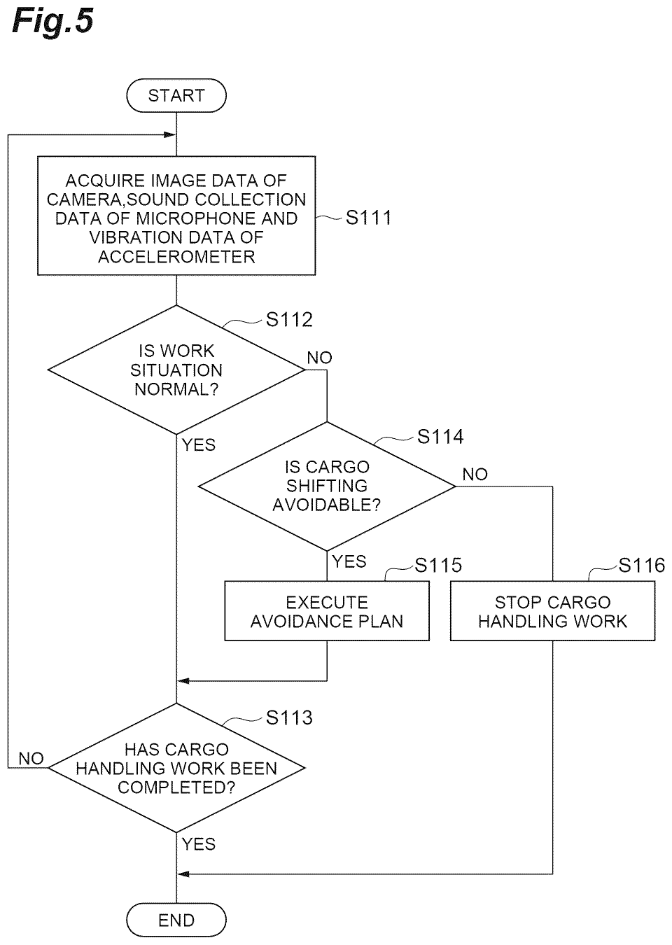

FIG. 5 is a flowchart indicating procedure of work situation determination processing to be executed by the controller 26. This processing is executed by the work situation information acquisition unit 34, the work situation abnormality determination unit 35, and the avoidance possibility determination unit 36. This processing is executed when the cargo handling work is started.

In FIG. 5, the controller 26 first acquires the image data of the camera 21, the sound collection data of the microphone 22, and the vibration data of the accelerometer 23 (step S111). Subsequently, the controller 26 judges whether a current working situation is normal based on the image data of the camera 21, the sound collection data of the microphone 22, and the vibration data of the accelerometer 23 (step S112).

For example, in a case where there is dragging of the cargo M, the dragging state appears in the captured image, and sound and vibration due to the dragging occur, and thus, it is comprehensively judged from the image data, the sound collection data, and the vibration data that it is an abnormal situation leading to cargo shifting. Thus, for example, even if dragging of the cargo M is not detected from the image data due to a blind spot of the camera 21, the dragging of the cargo M may be detected from the sound collection data and the vibration data. In this event, a threshold to be used for abnormality judgement of the work situation is also calculated from the modeled data stored in the storage unit 24.

When it is judged that the current work situation is normal, the controller 26 judges whether the cargo handling work has been completed (step S113). When it is judged that the cargo handling work has been completed, the controller 26 ends this processing. When it is judged that the cargo handling work has not been completed, the controller 26 executes the above processing in step S111 again.

When it is judged that the current work situation is abnormal in step S112, the controller 26 judges whether cargo shifting is avoidable using the modeled data stored in the storage unit 24 (step S114).

When it is judged that cargo shifting is avoidable, the controller 26 outputs that the avoidance plan is to be executed (step S115) and executes the processing in step S113. When it is judged that cargo shifting is not avoidable, the controller 26 outputs that the cargo handling work is to be stopped (step S116) and ends this processing.

Here, the work situation information acquisition unit 34 executes the processing in step S111 and step S113. The work situation abnormality determination unit 35 executes the processing in step S112. The avoidance possibility determination unit 36 executes the processing from step S114 to step S116.

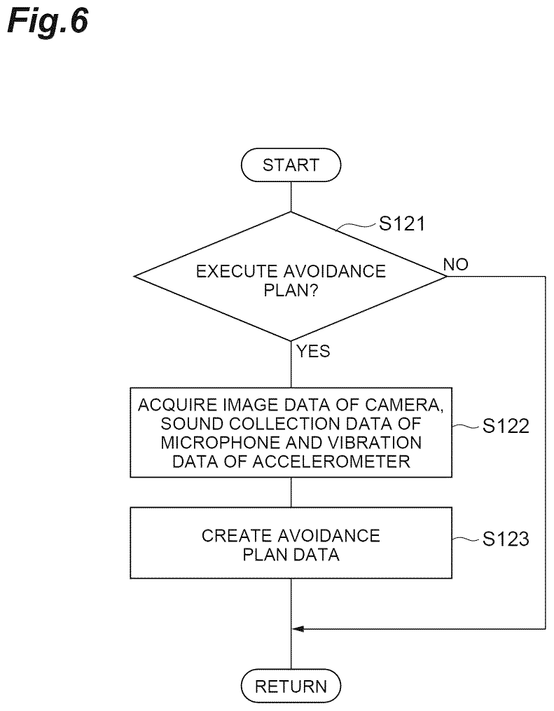

FIG. 6 is a flowchart indicating procedure of avoidance plan creation processing to be executed by the avoidance plan creation unit 37 of the controller 26. This processing is executed when the loaded state determination processing and the work situation determination processing are executed.

In FIG. 6, the controller 26 first judges whether to execute an avoidance plan based on the processing in step S105 and step S115 described above (step S121). When it is judged to execute the avoidance plan, the controller 26 acquires the image data of the camera 21, the sound collection data of the microphone 22, and the vibration data of the accelerometer 23 (step S122).

Subsequently, the controller 26 creates avoidance plan data for avoiding cargo shifting using the image data of the camera 21, the sound collection data of the microphone 22, the vibration data of the accelerometer 23, and the modeled data stored in the storage unit 24 (step S123). Specifically, the controller 26 obtains operation data corresponding to the image data of the camera 21, the sound collection data of the microphone 22, and the vibration data of the accelerometer 23 from the modeled data and creates control command data of the traveling device 2 and the cargo handling device 3 corresponding to the operation data as the avoidance plan data.

For example, as illustrated in FIG. 3, in a case where the cargo M on the second stage loaded on the pallet 10 on the right side interferes with the cargo M loaded on the pallet 10 on the left side (see A in the figure), avoidance plan data is created such that the right loaded pallet 10M is picked up before the left loaded pallet 10M even though pallets are normally picked up from the left side to the right side. In addition, if it is difficult to pick up the right loaded pallet 10M prior to than the left loaded pallet 10M, avoidance plan data in which the left loaded pallet 10M is picked up while being shifted to the left is created.

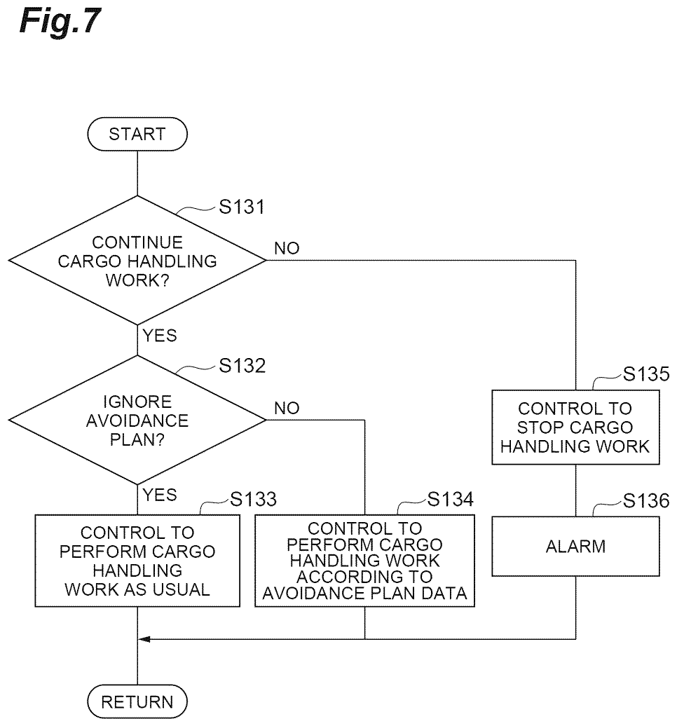

FIG. 7 is a flowchart indicating procedure of cargo handling control processing to be executed by the cargo handling control unit 38 of the controller 26. This processing is executed when the loaded state determination processing and the work situation determination processing are executed.

In FIG. 7, the controller 26 first judges whether or not to stop the cargo handling work based on the above-described processing in step S106 and step S116 (step S131). When it is judged not to stop the cargo handling work, the controller 26 judges whether or not to execute the avoidance plan based on the above processing in step S105 and step S115 (step S132).

When it is judged not to execute the avoidance plan, the controller 26 controls the traveling device 2 and the cargo handling device 3 so as to perform the cargo handling work as usual (step S133). The normal cargo handling work is, for example, work of performing picking up pallets in a predetermined order.

When it is judged to execute the avoidance plan, the controller 26 controls the traveling device 2 and the cargo handling device 3 to perform the cargo handling work according to the avoidance plan data created in the above processing in step S123 (step S134).

When it is judged to stop the cargo handling work in step S131, the controller 26 controls the traveling device 2 and the cargo handling device 3 so as to forcibly stop execution of the cargo handling work (step S135). Then, the controller 26 controls the alarm 25 to issue an alarm (step S136).

As described above, in the present embodiment, before the cargo handling work is started, the cargo M on the pallet 10 held by the forks 11 is detected as a loaded state together with the pallet 10 using the camera 21, and it is determined whether the loaded state is abnormal. When it is determined that the loaded state is abnormal, it is possible to suppress occurrence of cargo shifting due to interference, or the like, between adjacent cargos M by stopping the cargo handling work or performing operation of avoiding cargo shifting. After the cargo handling work is started, the work situation is detected using the camera 21, the microphone 22, and the accelerometer 23, and it is determined whether the work situation is abnormal. When it is determined that the work situation is abnormal, it is possible to suppress occurrence of cargo shifting to be caused by a situation leading to the cargo shifting, such as dragging of the cargo M, by stopping the cargo handling work or performing operation of avoiding cargo shifting. As described above, even if an abnormality of the loaded state is overlooked in detection of the loaded state, occurrence of cargo shifting can be suppressed by continuously monitoring the work situation during the cargo handling work.

In addition, in the present embodiment, by using the camera 21, it is possible to easily and inexpensively detect the loaded state including the cargo M and the pallet 10.

In the present embodiment, by using the camera 21, the microphone 22, and the accelerometer 23, it is possible to detect, in a wide range and with high accuracy, an abnormality in the work situation that leads to cargo shifting, such as dragging of the cargo M and collision between the cargos M which occur during the cargo handling work.

In addition, in the present embodiment, by using the modeled data in which the operation data of the forklift 1 by the operator is associated with the image data of the camera 21 detected, the sound collection data of the microphone 22, and the vibration data of the accelerometer 23 at the time of the operation of the forklift 1, it is determined whether the loaded state and the work situation are abnormal based on a result of modeling actual abnormality recognition and judgement by the operator. It is therefore possible to appropriately determine whether or not the loaded state and the work situation are abnormal.

In addition, in the present embodiment, when it is determined that the loaded state or the work situation is abnormal, avoidance plan data for avoiding cargo shifting is created, and the forklift 1 is controlled to perform the cargo handling work according to the avoidance plan data. Thus, occurrence of cargo shifting is automatically suppressed.

In addition, in the present embodiment, in a case where it is determined that the loaded state or the work situation is abnormal, the avoidance plan data is created when it is determined that cargo shifting is avoidable, and the forklift 1 is controlled to stop the cargo handling work when it is determined that cargo shifting is not avoidable. The avoidance plan data is created as necessary in this manner, so that it is not necessary to wastefully create the avoidance plan data. This can simplify the processing in the controller 26.

In addition, in the present embodiment, by using the modeled data in which the operation data of the forklift 1 by the operator is associated with the image data of the camera 21, the sound collection data of the microphone 22, and the vibration data of the accelerometer 23 detected at the time of the operation of the forklift 1, it is determined whether cargo shifting of the cargo M is avoidable based on a result of modeling actual abnormality recognition and judgement by the operator. It is therefore possible to appropriately determine whether or not cargo shifting of the cargo M is avoidable.

Furthermore, in the present embodiment, the avoidance plan data is created using the modeled data in which the operation data of the forklift 1 by the operator is associated with the image data of the camera 21, the sound collection data of the microphone 22, and the vibration data of the accelerometer 23 detected at the time of the operation of the forklift 1, so that it is possible to obtain the avoidance plan data based on a result of modeling actual abnormality recognition and judgement by the operator. Thus, occurrence of cargo shifting can be appropriately suppressed.

Note that the present disclosure is not limited to the above embodiment. For example, in the above embodiment, the loaded state of the loaded pallet 10M is detected using the camera 21 before the cargo handling work is started, but the present disclosure is not particularly limited to such a form. For example, the loaded state of the loaded pallet 10M may be detected using a laser sensor such as LiDAR instead of the camera 21 or together with the camera 21. In other words, it is only necessary to detect the loaded state of the loaded pallet 10M using at least one type of sensor.

In the above embodiment, the work situation is detected using the camera 21, the microphone 22, and the accelerometer 23 after the cargo handling work is started, but the present disclosure is not particularly limited thereto, and the work situation may be detected using a plurality of types of sensors.

In the above embodiment, the storage unit 24 stores the modeled data in which the operation data of the forklift 1 by the operator is associated with the image data of the camera 21, the sound collection data of the microphone 22, and the vibration data of the accelerometer 23 detected at the time of the operation of the forklift 1. However, the present disclosure is not particularly limited to such a form. The storage unit 24 may store modeled data in which the operation data of the forklift 1 by the operator is associated with any one of the image data of the camera 21, the sound collection data of the microphone 22, and the vibration data of the accelerometer 23 detected at the time of the operation of the forklift 1. The storage unit 24 may store modeled data in which the operation data of the forklift 1 by the operator is associated with information on the loaded state and the work situation.

Further, in the above embodiment, the modeled data obtained by modeling recognition, judgement, and operation of the person with respect to various loaded states and work situations is used to detect the loaded state and the work situation of the loaded pallet 10M, determine whether or not cargo shifting is avoidable, and create the avoidance plan data. However, the present disclosure is not particularly limited to such a form, and data, or the like, obtained by establishing rules in advance may be used instead of data obtained by modeling recognition, judgement, and operation of the person.

Further, in the above embodiment, the cargo picking-up work is performed as the cargo handling work, but the cargo handling work is not particularly limited to the cargo picking-up work, and for example, a so-called unloading work of placing the loaded pallet 10M at a position adjacent to existing another loaded pallet 10M may be performed.

In the above embodiment, the cargo handling work is performed by automatic operation of the forklift 1. However, the cargo handling system of the present disclosure may be applied to work support of the cargo handling work by manual operation of the forklift 1 or may be applied to work support of the cargo handling work by remote operation of the forklift 1. In this case, for example, notification and alarm of the detection result of the loaded state of the loaded pallet 10M and the work situation, guide presentation of avoidance operation for avoiding cargo shifting, instruction to stop the work, and the like, are performed.

In the above embodiment, the sensor such as the camera 21 to be used for detecting the loaded state of the loaded pallet 10M and the work situation is mounted on the forklift 1, but the present disclosure is not particularly limited thereto, and the sensor may be installed on the infrastructure side. In this case, output data of the sensor may be transmitted to the forklift 1 by wireless communication, or the like, or the processing of the controller 26 may be executed on the infrastructure side.

### REFERENCE SIGNS LIST

1 Forklift
10 Pallet
11 Fork
20 Cargo handling system
21 Camera (sensor, first detection unit, second detection unit)
22 Microphone (sensor, second detection unit)
23 Accelerometer (vibration sensor, sensor, second detection unit)
24 Storage unit
31 Loaded state information acquisition unit (first detection unit)
32 Loaded state abnormality determination unit (first abnormality determination unit)
33 Avoidance possibility determination unit
34 Work situation information acquisition unit (second detection unit)
35 Work situation abnormality determination unit (second abnormality determination unit)
36 Avoidance possibility determination unit
37 Avoidance plan creation unit
38 Cargo handling control unit
M Cargo

What is claimed is:

1. A cargo handling system that performs cargo handling work with a forklift, the cargo handling system comprising:
a first detection unit configured to detect a cargo on a pallet held by a fork of the forklift as a loaded state together with the pallet using at least one type of sensor before the cargo handling work is started;
a first abnormality determination unit configured to determine whether the loaded state detected by the first detection unit is abnormal;
a second detection unit configured to detect a work situation using a plurality of types of sensors after the cargo handling work is started; and
a second abnormality determination unit configured to determine whether the work situation detected by the second detection unit is abnormal.

2. The cargo handling system according to claim 1, wherein the one type of sensor is a camera that captures an image of the pallet and the cargo.

3. The cargo handling system according to claim 1, wherein the plurality of types of sensors includes a camera that captures an image of the pallet and the cargo, a microphone that collects sound around the forklift, and a vibration sensor that measures vibration applied to the fork.

4. The cargo handling system according to claim 1, further comprising:
a storage unit configured to store modeled data in which operation data of the forklift by an operator is associated with information on the loaded state detected by the first detection unit and information on the work situation detected by the second detection unit when the cargo handling work is performed by manual operation of the forklift, wherein
the first abnormality determination unit determines whether the loaded state detected by the first detection unit is abnormal using the modeled data stored in the storage unit, and
the second abnormality determination unit determines whether the work situation detected by the second detection unit is abnormal using the modeled data stored in the storage unit.

5. The cargo handling system according to claim 1, further comprising:
an avoidance plan creation unit configured to create avoidance plan data for avoiding cargo shifting of the cargo when the first abnormality determination unit determines that the loaded state is abnormal or when the second abnormality determination unit determines that the work situation is abnormal; and
a cargo handling control unit configured to control the forklift to perform the cargo handling work in accordance with the avoidance plan data created by the avoidance plan creation unit.

6. The cargo handling system according to claim 5, further comprising:
an avoidance possibility determination unit configured to determine whether cargo shifting of the cargo is avoidable when the first abnormality determination unit determines that loaded state is abnormal or when the second abnormality determination unit determines that the work situation is abnormal, wherein
the avoidance plan creation unit creates the avoidance plan data when the avoidance possibility determination unit determines that the cargo shifting is avoidable, and
the cargo handling control unit controls the forklift to stop the cargo handling work when the avoidance possibility determination unit determines that the cargo shifting is not avoidable.

7. The cargo handling system according to claim 6, further comprising:
a storage unit configured to store modeled data in which operation data of the forklift by an operator is associated with information on the loaded state detected by the first detection unit and information on the work situation detected by the second detection unit when the cargo handling work is performed by manual operation of the forklift, wherein
the avoidance possibility determination unit determines whether the cargo shifting of the cargo is avoidable using the modeled data stored in the storage unit.

8. The cargo handling system according to claim 5, further comprising:
a storage unit configured to store modeled data in which operation data of the forklift by an operator is associated with information on the loaded state detected by the first detection unit and information on the work situation detected by the second detection unit when the cargo handling work is performed by manual operation of the forklift, wherein
the avoidance plan creation unit creates the avoidance plan data using the information on the loaded state detected by the first detection unit and the modeled data stored in the storage unit in a case where the first abnormality determination unit determines that the loaded state is abnormal and when it is determined that the cargo shifting is avoidable, and creates the avoidance plan data using the information on the work situation detected by the second detection unit and the modeled data stored in the storage unit in a case where the second abnormality determination unit determines that the work situation is abnormal and when it is determined that the cargo shifting is avoidable.
